(19) United States
(12) Patent Application Publication
(10) Pub. No.: US 2002/0128896 A1
(43) Pub. Date: Sep. 12, 2002

(54) Information management system and information display method applied to the same

(75) Inventors: Kazuyuki Matsuda, Ome-shi (JP); Toshio Yoshida, Kunitachi-shi (JP); Tsuyoshi Matsuzaki, Yokohama-shi (JP); Ichirou Kikukawa, Ebina-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/086,366

(22) Filed: Mar. 4, 2002

(30) Foreign Application Priority Data
Mar. 6, 2001 (JP) 2001-062337

(51) Int. Cl. G06F 17/60

(52) U.S. Cl. 705/9

(57) ABSTRACT

In an information display method applied to an information management system for managing a plurality of jobs, a plurality of information items, respectively associated with the plurality of jobs, are stored. When a user designates an attribute serving as a reference for information classification, information contained in the plurality of information items is classified with reference to the designated attribute and the classified information is displayed.

### CROSS-REFERENCE TO RELATED APPLICATIONS

This application is based upon and claims the benefit of priority from the prior Japanese Patent Application No. 2001-062337, filed Mar. 6, 2001, the entire contents of which are incorporated herein by reference.

### BACKGROUND OF THE INVENTION

1. Field of the Invention

The present invention relates to an information management system and an information display method applied to the system.

2. Description of the Related Art

Recently, in business entities, various types of software are used to manage information in accordance with various applications. Examples of known software are ERP (Enterprise Resource Planning) software for performing accounting, production control, sales management, and the like in a business entity and PDM (Product Data Management) software for managing various steps, e.g., product-planning, design, and manufacture.

In the manufacturing industry, for example, in order to manage the man-hour load resulting from product design and also manage results (a design specification, analysis result, and the like) of product design, ERP software capable of managing a man-hour load and PDM software capable of managing results may be installed in computer, thereby constructing an information searching/browsing system.

On the constructed system, however, various types of software such as ERP software and PDM software exist independently of each other. It is therefore not easy to efficiently manage both a man-hour load and results while ensuring information matching among the software programs.

When, for example, the user of the system inputs various information and searches/browses information, the user must select a corresponding software program first and then must perform necessary input operation for each software program. If information input on a given software program influences another software program, the user must perform input operation for each software program in consideration of information matching between the software programs. As a consequence, a heavy load is imposed on the user of the system.

Assume that a system capable of handling both information about a man-hour load and results while attaining information matching between software programs can be constructed independently. In practice, however, the system must handle other information such as a section in charge of operation (or person in charge) as well as a man-hour load and results. This makes it necessary to construct a complicated mechanism separately.

Under the circumstances, demands have arisen for an information management system capable of efficiently performing information input operation, information searching/browsing operation, and the like without imposing any burden on a user.

### BRIEF SUMMARY OF THE INVENTION

According to one aspect of the present invention, there is provided an information display method applied to an information management system for managing a plurality of jobs, comprising: storing a plurality of information items respectively associated with the plurality of jobs; causing a user to designate an attribute serving as a reference for information classification; and classifying information contained in the plurality of information items with reference to the designated attribute and displaying the classified information.

According to another aspect of the present invention, there is provided an information management system for managing a plurality of jobs, comprising: a storage unit storing a plurality of information items respectively associated with the plurality of jobs; a designation unit configured to cause a user to designate an attribute serving as a reference for information classification; and a display control unit configured to classify information contained in the plurality of information items with reference to the designated attribute and to display the classified information.

According to still another aspect of the present invention, there is provided a storage medium storing computer-executable program code for displaying information by using a plurality of information items respectively associated with a plurality of jobs, the program code comprising: causing a user to designate an attribute serving as a reference for information classification; and classifying information contained in the plurality of information items with reference to the designated attribute and displaying the classified information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a data structure used in an information management system according to an embodiment of the present invention;

FIG. 2 is a view showing an example of the arrangement of information managed by the information management system;

FIG. 3 is a view showing an example of the system arrangement of the hardware of the information management system;

FIG. 4 is a view showing a window for allowing the user of the information management system to make display settings;

FIG. 5 is a flow chart for explaining the operation of this embodiment;

FIG. 6 is a view showing an example of the display window contents formed when “target component” is designated as an attribute; and

FIG. 7 is a view showing an example of the display window contents formed when “person in charge” is designated as an attribute.

### DETAILED DESCRIPTION OF THE INVENTION

An embodiment of the present invention will be described below with reference to the views of the accompanying drawing.

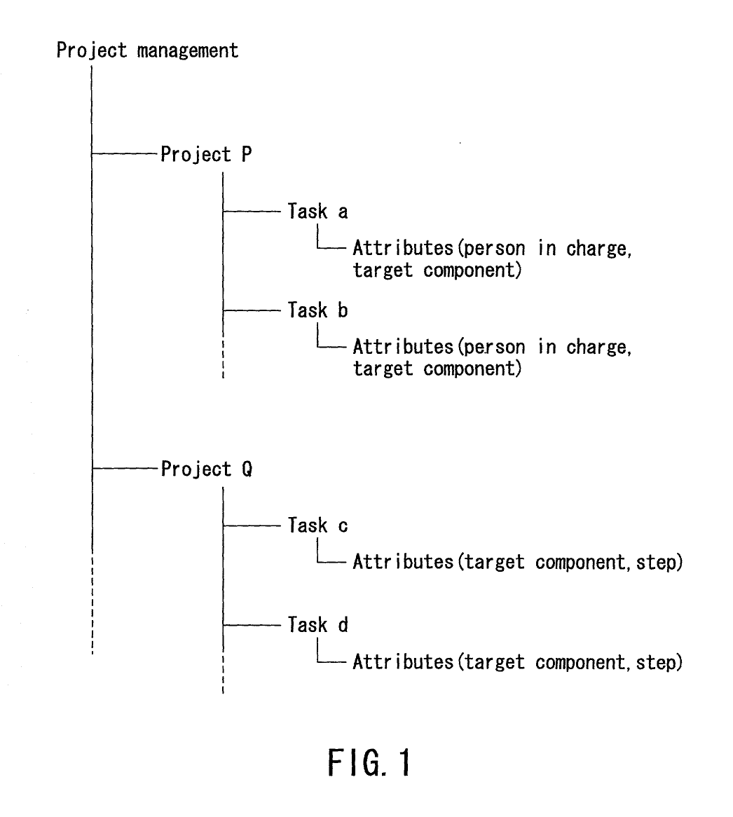

FIG. 1 is a view showing a data structure used in an information management system according to an embodiment of the present invention.

The information management system according to this embodiment uses a WBS (Work Breakdown Structure) in project management software for managing tasks (jobs) on a project basis. As shown in FIG. 1, the software (one) handled in the information management system manages a plurality of projects. Each project is comprised of a plurality of tasks.

In this arrangement, according to this embodiment, “attributes” associated with each task can be defined for each project, as needed. For a project P, for example, “person in charge” and “target component” are defined as attributes common to each task. For a project Q, “target component” and “step” can be defined as attributes common to each task.

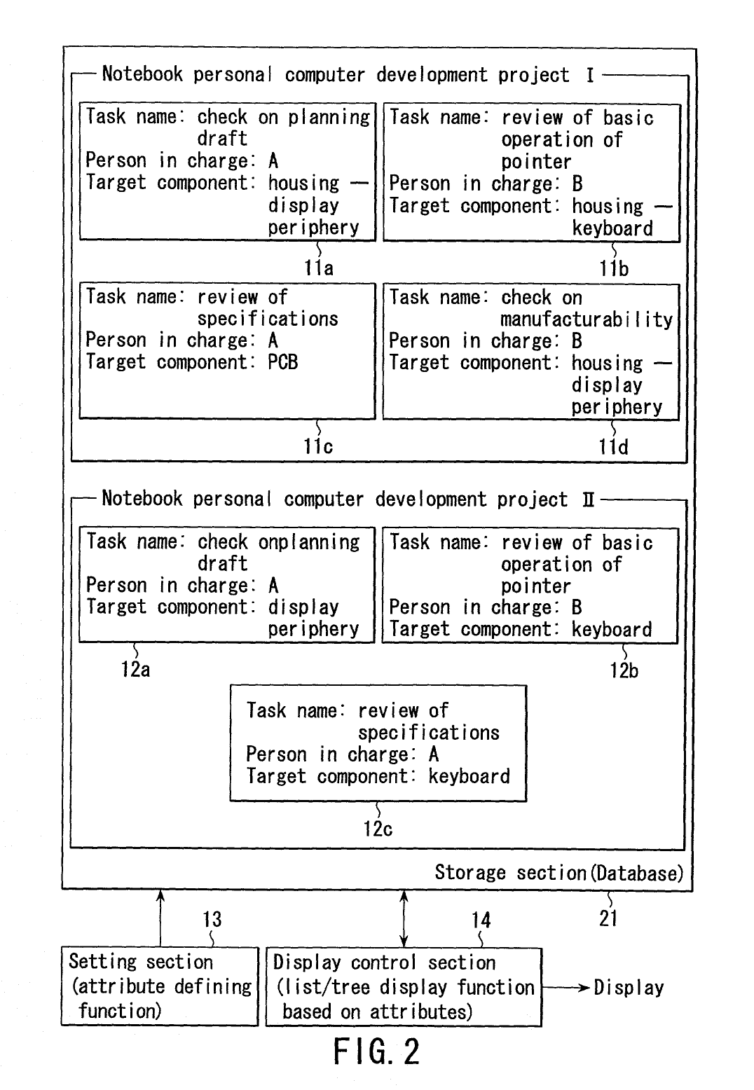

FIG. 2 is a view showing an example of the arrangement of information managed by this information management system.

Information items associated with tasks constituting each project are stored in a storage section (database) 21.

More specifically, the storage section 21 stores information items 11a to 11d corresponding to a plurality of tasks (task names: “check on planning draft”, “review of basic operation of pointer”, “review of specifications”, and “check on manufacturability”) constituting “notebook personal computer development project I” of a plurality of projects, together with information items 12a to 12c corresponding to a plurality of tasks (task names: “check on planning draft”, “review of basic operation of pointer”, and “review of specifications”) constituting “notebook personal computer development project II”.

In the case shown in FIG. 2, “person in charge” and “target component” are defined as the attributes of each task of both “notebook personal computer development project I” and “notebook personal computer development project II”. In this case, with respect to the attributes “person in charge” and “target component” of each information item, specific information (e.g., person in charge: A, target component: housing-display periphery) is described separately. Note that the description “housing-display periphery” indicates that a portion, of the housing, which is located around a display is a target portion, in particular. That is, “- (hyphen)” is used to add a subcategory. A setting section (attribute defining function) 13 defines and sets such attributes in accordance with input operation by the user.

A display control section (list/tree display function based on attributes) 14 recognizes the project name (“notebook personal computer development project I” or “notebook personal computer development project II”) of a designated display target in accordance with input operation by the user, an attribute (“person in charge” or “target component”) serving as a reference for information classification, and a display form (list display or tree display or both), and forms corresponding contents displayed on the screen by using the information items stored in the storage section 21.

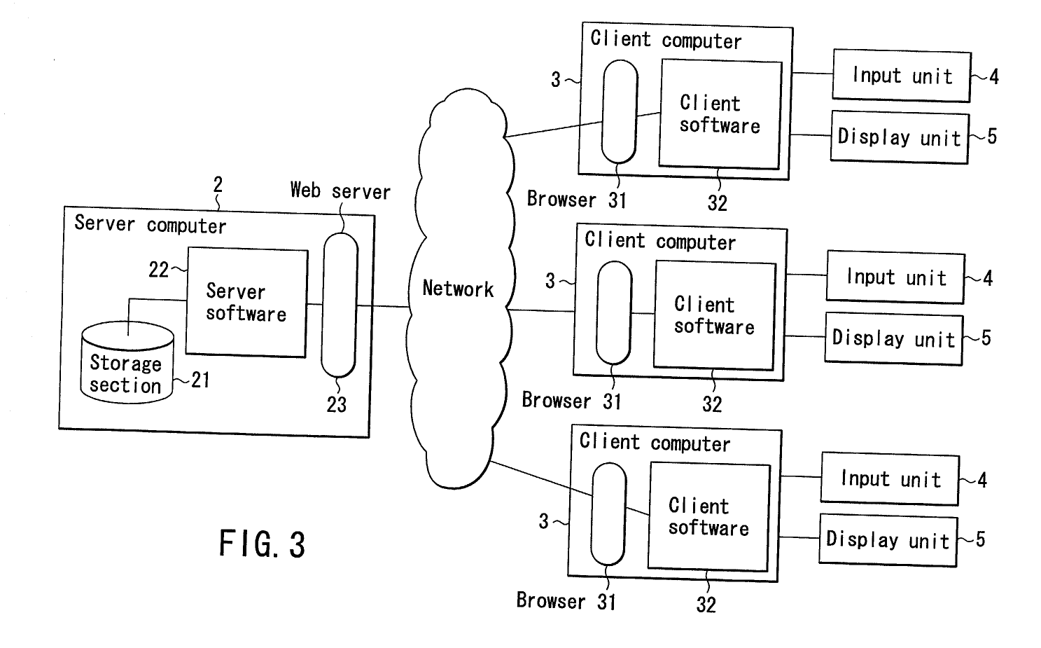

FIG. 3 is a view showing an example of the system arrangement of hardware for implementing information management according to this embodiment.

As shown in FIG. 3, this system is constituted by one server computer 2 and a plurality of client computers 3 which are connected to each other through, for example, a network. The server computer 2 includes a server software 22 and Web server 23. Each client computer 3 includes a browser 31 and client software 32. The client computer 3 also includes an input unit 4 such as a keyboard and mouse and a display unit 5.

The storage section 21 in the server computer 2 stores information items corresponding to tasks of each project, as shown in FIG. 2.

The server software 22 selects and extracts information from the storage section 21 in accordance with a request sent from the client computer 3, as needed, and supplies the information to the client computer 3 as the request source through the Web server 23.

The Web server 23 is connected to the network and transmits/receive information between the server computer 2 and each client computer 3.

The browser 31 in the client computer 3 captures necessary information from the server computer 2 through the network in accordance with the request indicated by the client software 32.

The client software 32 performs processing to capture information in accordance with an instruction from the input unit 4 or displays the information captured by the browser 31 on the screen of the display unit 5.

Note that the above setting section 13 and display control section 14 are provided for one or both of the server software 22 and the client software 32.

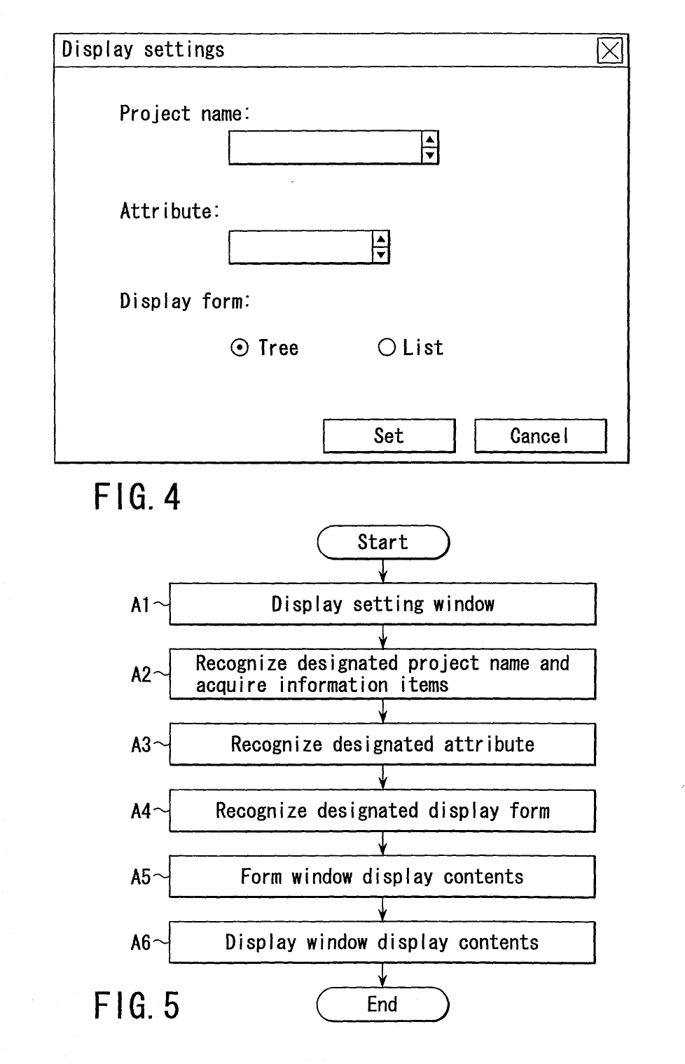

FIG. 4 is a view showing a window for allowing the user of the system to make display settings.

The window shown in FIG. 4 is a display setting window displayed on the display unit 5 of the client computer 3. This window has fields for designating a project name, attribute (as a reference for information classification), and display form. The user of the system can designate desired contents with respect to the respective fields.

As a project name, for example, “notebook personal computer development project I” or “notebook personal computer development project II” is designated. As an attribute, “person in charge”, “target component”, or the like is designated. As a display form, “list display”, “tree display”, or the like is designated.

The operation of this embodiment will be described next with reference to the flow chart of FIG. 5.

The user of the system displays the display setting window (FIG. 4) on the display unit 5 of the client computer 3 (step A1). On the displayed window, the user designates a project name, attribute, and display form by using the input unit 4.

The display control section 14 recognizes the contents of the designated project name and acquires a plurality of information items in a corresponding project from the storage section 21 of the server computer 2 (step A2). The display control section 14 also recognizes the contents of the designated attribute (step A3) and recognizes the designated display form (step A4).

The display control section 14 classifies/arranges various types of information contained in the acquired information items with reference to the designated attribute and forms window display contents to be displayed on the display unit 5 of the client computer 3 (step AS). With this operation, the formed window display contents are displayed on the display unit 5 of the client computer 3 of the user (step A6).

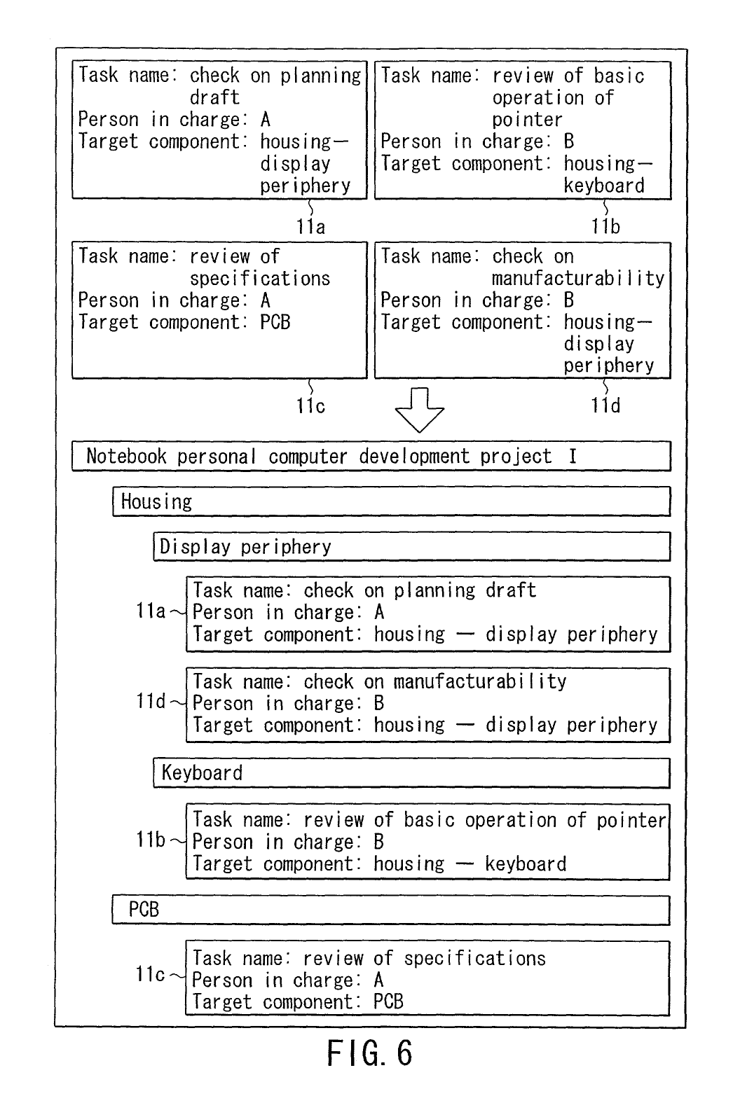

FIG. 6 shows an example of the display window contents formed when “target component” is designated as an attribute. In this case, “notebook personal computer development project I” is designated as a project name, and “tree display” is designated as a display form.

As is obvious from FIG. 6, the information items 11a to 11d of the tasks constituting “notebook personal computer development project I” are displayed on the upper portion of the display window, whereas pieces of information associated with “notebook personal computer development project I” are arranged in a tree display form (hierarchical structure) with reference the designated attribute “target component” on the lower portion of the display window.

In this case, as for target components, “housing” and “PCB” are arranged as upper-level categories, and “display periphery” and “keyboard” are arranged as subcategories on the lower-level of “housing”. The information items 11a and 11d are arranged below “housing-display periphery” serving as a target component, the information item 11b is placed below “housing-keyboard”, and the information item 11c is placed below “PCB”.

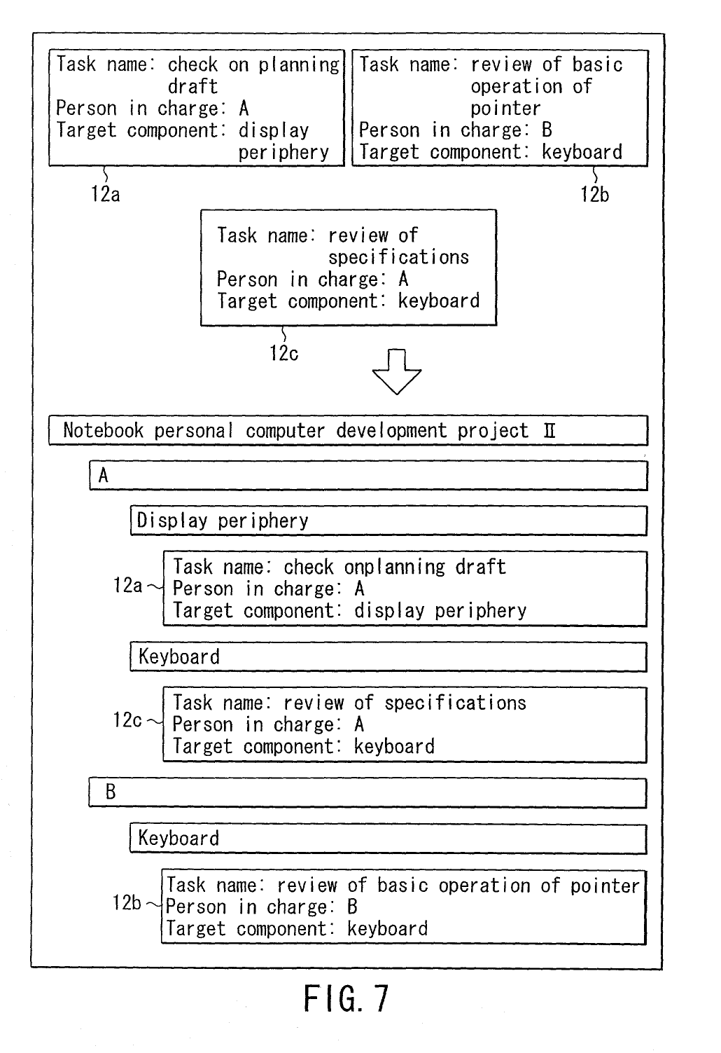

FIG. 7 shows an example of the display window contents formed when “person in charge” is designated as an attribute. In this case, “notebook personal computer development project II” is designated as a project name, and “tree display” is designated as a display form.

As is obvious from FIG. 7, the information items 12a to 12c of the tasks constituting “notebook personal computer development project II” are displayed on the upper portion of the display window, whereas pieces of information associated with “notebook personal computer development project II” are arranged on the lower portion of the display window in a tree display form with reference to the designated attribute “person in charge”.

In this case, “A” and “B” as persons in charge are arranged as upper-level categories, and “display periphery” and “keyboard” of which A takes charge are arranged below “A”. The corresponding information items 12a and 12c are respectively arranged below “display periphery” and “keyboard”. In addition, the component “keyboard” of which B takes charge is placed below “B”, and the information item 12b is placed below “keyboard”.

As described above, according to the present invention, since information can be expressed in the WBS form, the user of the system can perform information management in the same manner as general business operation. In addition, a desired display form can be realized by designating an attribute as a reference for information classification as needed. Furthermore, an environment that allows a user to smoothly perform versatile information searching/browsing operation without imposing any burden on the user can be implemented through one software program.

Note that the present invention is not limited to the above embodiment, and various changes and modifications can be made within the spirit and scope of the invention.

The various processing procedures associated with the present invention described in the above embodiment may be stored in advance as computer-executable program codes in a computer-readable storage medium (e.g., a magnetic disk, optical disk, or semiconductor memory). Such a program may be read out from the medium by a computer (processor) to be executed, as needed. Such computer-executable program codes may be transmitted and distributed from a given computer to another computer through a communication medium.

In the above embodiment, “task” in the project management system is regarded as a management target. However, the present invention is not limited to this. Various operations, e.g., jobs in another system, may be set as management targets.

According to the present invention described in detail above, operations such as information inputting, searching, browsing operations can be efficiently performed while the burden on the user is reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information display method applied to an information management system for managing a plurality of jobs, comprising:
storing a plurality of information items respectively associated with the plurality of jobs;
causing a user to designate an attribute serving as a reference for information classification; and
classifying information contained in the plurality of information items with reference to the designated attribute and displaying the classified information.

2. An information display method applied to an information management system for managing a plurality of tasks, comprising:
storing a plurality of information items respectively associated with the plurality of tasks;
causing a user to designate an attribute serving as a reference for information classification; and
classifying information contained in the plurality of information items with reference to the designated attribute and displaying the classified information.

3. The method according to claim 2, wherein the displaying includes displaying the classified information in at least one of a list display form and a tree display form.

4. The method according to claim 2, wherein a task name and at least two types of attributes are described in each of the plurality of information items.

5. The method according to claim 2, further comprising displaying contents of each of the plurality of information items.

6. An information management system for managing a plurality of jobs, comprising:
a storage unit storing a plurality of information items respectively associated with the plurality of jobs;
a designation unit configured to cause a user to designate an attribute serving as a reference for information classification; and
a display control unit configured to classify information contained in the plurality of information items with reference to the designated attribute and to display the classified information.

7. An information management system for managing a plurality of tasks, comprising:
a storage unit storing a plurality of information items respectively associated with the plurality of tasks;
a designation unit configured to cause a user to designate an attribute serving as a reference for information classification; and
a display control unit configured to classify information contained in the plurality of information items with reference to the designated attribute and to display the classified information.

8. The system according to claim 7, wherein said display control unit displays the classified information in at least one of a list display form and a tree display form.

9. The system according to claim 7, wherein a task name and at least two types of attributes are described in each of the plurality of information items stored in said storage unit.

10. The system according to claim 7, wherein said display control unit further displays contents of each of the plurality of information items.

11. A storage medium storing computer-executable program code for displaying information by using a plurality of information items respectively associated with a plurality of jobs, the program code comprising:
causing a user to designate an attribute serving as a reference for information classification; and
classifying information contained in the plurality of information items with reference to the designated attribute and displaying the classified information.

12. A storage medium storing computer-executable program code for displaying information by using a plurality of information items respectively associated with a plurality of jobs, the program code comprising:
causing a user to designate an attribute serving as a reference for information classification; and
classifying information contained in the plurality of information items with reference to the designated attribute and displaying the classified information.

13. The medium according to claim 12, wherein the displaying includes displaying the classified information in at least one of a list display form and a tree display form.

14. The medium according to claim 12, wherein a task name and at least two types of attributes are described in each of the plurality of information items.

15. The medium according to claim 12, further comprising displaying contents of each of the plurality of information items.
